(19) United States
(12) Patent Application Publication
(10) Pub. No.: US 2020/0050353 A1
(43) Pub. Date: Feb. 13, 2020

(54) ROBUST GESTURE RECOGNIZER FOR PROJECTOR-CAMERA INTERACTIVE DISPLAYS USING DEEP NEURAL NETWORKS WITH A DEPTH CAMERA

(71) Applicant: FUJI XEROX CO., LTD., Tokyo (JP)

(72) Inventors: Patrick CHIU, Mountain View, CA (US); Chelhwon KIM, Palo Alto, CA (US)

(73) Assignee: FUJI XEROX CO., LTD.

(21) Appl. No.: 16/059,659

(22) Filed: Aug. 9, 2018

(51) Int. Cl. G06F 3/0488; G06K 9/62; G06K 9/00; G06N 3/04; G06N 3/08; G03B 21/14; H04N 5/232

(52) U.S. Cl. CPC G06F 3/04883; G06K 9/6256; G06K 9/00355; H04N 5/23229; G06N 3/086; G03B 21/14; G06N 3/04

(57) ABSTRACT

Systems and methods described herein utilize a deep learning algorithm to recognize gestures and other actions on a projected user interface provided by a projector. A camera that incorporates depth information and color information records gestures and actions detected on the projected user interface. The deep learning algorithm can be configured to be engaged when an action is detected to save on processing cycles for the hardware system.

### BACKGROUND

### Field

The present disclosure is related generally to gesture detection, and more specifically, to gesture detection on projection systems.

### Related Art

Projector-camera systems can turn any surface such as tabletops and walls into an interactive display. A basic problem is to recognize the gesture actions on the projected user interface (UI) widgets. Related art approaches using finger models or occlusion patterns have a number of problems including environmental lighting conditions with brightness issues and reflections, artifacts and noise in the video images of a projection, and inaccuracies with depth cameras.

### SUMMARY

In the present disclosure, example implementations described herein address the problems in the related art by providing a more robust recognizer through employing a deep neural net approach with a depth camera. Specifically, example implementations utilize a convolutional neural network (CNN) with optical flow computed from the color and depth channels. Example implementations involve a processing pipeline that also filters out frames without activity near the display surface, which saves computation cycles and energy. In tests of the example implementations described herein utilizing a labeled dataset, high accuracy (e.g.,
95% accuracy) was achieved.

Aspects of the present disclosure can include a system, which involves a projector system, configured to project a user interface (UI); a camera system, configured to record interactions on the projected user interface; and a processor, configured to, upon detection of an interaction recorded by the camera system, determine execution of a command for action based on an application of a deep learning algorithm trained to recognize gesture actions from the interaction recorded by the camera system.

Aspects of the present disclosure can include a system, which involves means for projecting a user interface (UI); means for recording interactions on the projected user interface; and means for, upon detection of a recorded interaction, determining execution of a command for action based on an application of a deep learning algorithm trained to recognize gesture actions from recorded interactions.

Aspects of the present disclosure can include a method, which involves projecting a user interface (UI); recording interactions on the projected user interface; and upon detection of an interaction recorded by the camera system, determining execution of a command for action based on an application of a deep learning algorithm trained to recognize gesture actions from recorded interactions.

Aspects of the present disclosure can include a system, which can involve a projector system, configured to project a user interface (UI); a camera system, configured to record interactions on the projected user interface; and a processor, configured to, upon detection of an interaction recorded by the camera system, compute an optical flow for a region within the projected UI for color channels and depth channels of the camera system; apply a deep learning algorithm on the optical flow to recognize a gesture action, the deep learning algorithm trained to recognize gesture actions from the optical flow; and for the gesture action being recognized, execute a command corresponding to the recognized gesture action.

Aspects of the present disclosure can include a system, which can involve means for projecting a user interface (UI); means for recording interactions on the projected user interface; means for, upon detection of a recorded interaction, computing an optical flow for a region within the projected UI for color channels and depth channels of the camera system; means for applying a deep learning algorithm on the optical flow to recognize a gesture action, the deep learning algorithm trained to recognize gesture actions from the optical flow; and for the gesture action being recognized, means for executing a command corresponding to the recognized gesture action.

Aspects of the present disclosure can include a method, which can involve projecting a user interface (UI); recording interactions on the projected user interface; upon detection of an interaction recorded by the camera system, computing an optical flow for a region within the projected UI for color channels and depth channels of the camera system; applying a deep learning algorithm on the optical flow to recognize a gesture action, the deep learning algorithm trained to recognize gesture actions from the optical flow; and for the gesture action being recognized, means for executing a command corresponding to the recognized gesture action.

### BRIEF DESCRIPTION OF DRAWINGS

FIGS. 1(a) and 1(b) illustrates an example hardware diagram of a system involving a projector-camera setup, in accordance with an example implementation.

FIG. 2(a) illustrates example sample frames for a projector and camera system, in accordance with an example implementation.

FIG. 2(b) illustrates a table with example problems regarding techniques utilized by the related art.

FIG. 2(c) illustrates an example database of optical flows as associated with labeled actions in accordance with an example implementation.

FIG. 3 illustrates an example flow diagram for the video frame processing pipeline, in accordance with an example implementation.

FIG. 4(a) illustrates an example overall flow, in accordance with an example implementation.

FIG. 4(b) illustrates an example flow to generate a deep learning algorithm as described in the present disclosure.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations are directed to the utilization of machine learning based algorithms. In the related art, a wide range of machine learning based algorithms have been applied to image or pattern recognition, such as the recognition of obstacles or traffic signs of other cars, or the categorization of elements based on a specific training. In view of the advancement in power computations, machine learning has become more applicable for the detection and generation of gestures on projected UI interfaces.

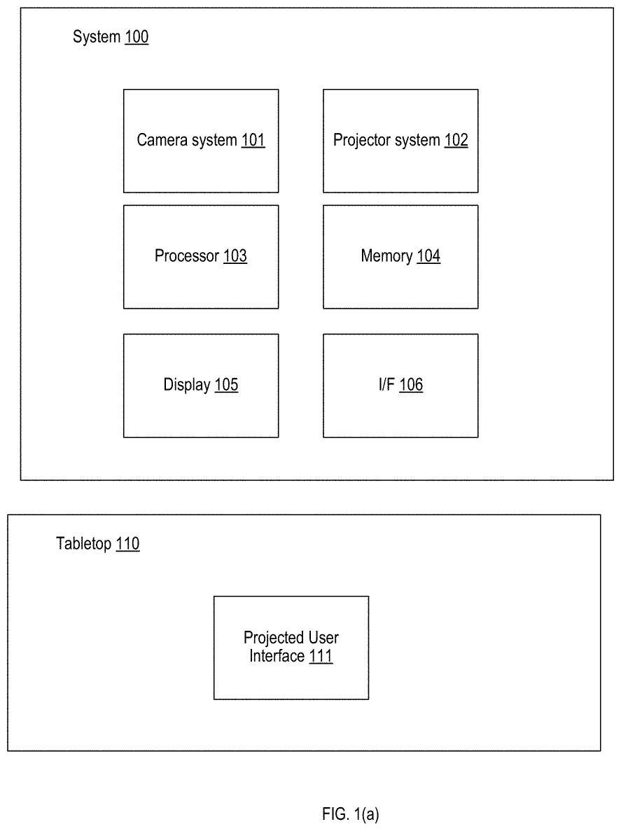

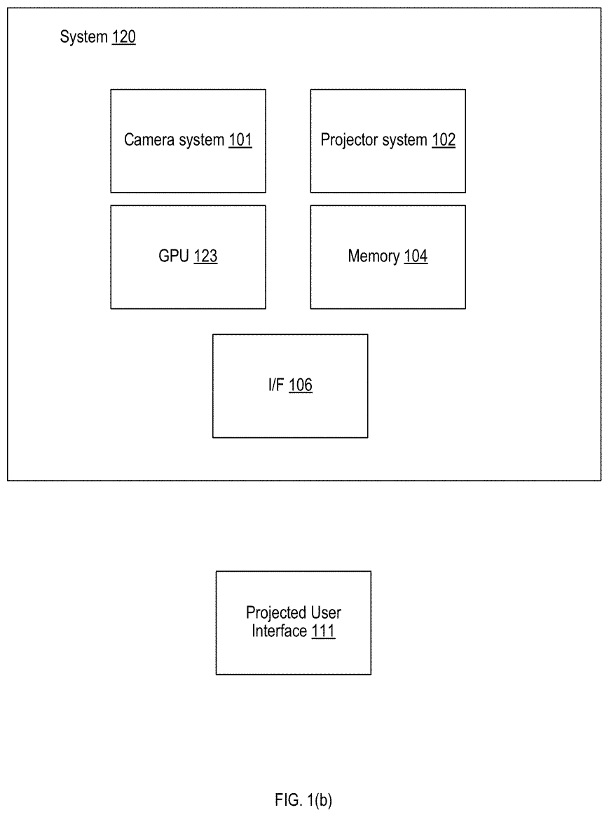

Projector-camera systems can turn any surface such as tabletops and walls into an interactive display. By projecting UI widgets onto the surfaces, users can interact with familiar graphical user interface elements such as buttons. For recognizing finger actions on the widgets (e.g. Press gesture, Swipe gesture), computer vision methods can be applied. Depth cameras with color and depth channels can also be employed to provide data with 3D information. FIGS. 1(a) and 1(b) illustrate example projector-camera systems in accordance with example implementations described herein.

FIG. 1(a) illustrates an example hardware diagram of a system involving a projector-camera setup, in accordance with an example implementation. System 100 can include a camera system for gesture/UI interaction capture 101, a projector 102, a processor 103, memory 104, a display 105, and an interface (UF) 106. The system 100 is configured to monitor a tabletop 110 on which a UI 111 is projected on the tabletop 110 by projector 102. Tabletop 110 can be in the form of a smart desk, a conference table, a countertop, and so on according to the desired implementation. Alternatively, other surfaces can be utilized, such as a wall surface, a building column, or any other physical surfaces upon which the UI 111 may be projected.

The camera system 101 can be in any form that is configured to capture video image and depth image according to the desired implementation. In an example implementation, processor 103 may utilize the camera system to capture images of interactions occurring at the projected UI 111 on the tabletop 110. The projector 102 can be configured to project a UI 111 onto a tabletop 110 and can be any type of projector according to the desired implementation. In an example implementation, the projector 102 can also be a holographic projector for projecting the UI into free space.

Display 105 can be in the form of a touchscreen or any other display for video conferencing or for displaying results of a computer device, in accordance with the desired implementation. Display 105 can also include a set of displays with a central controller that show conference participants or loaded documents in accordance with the desired implementation. I/F 106 can include interface devices such as keyboards, mouse, touchpads, or other input devices for display 105 depending on the desired implementation.

In example implementations, processor 103 can be in the form of a central processing unit (CPU) including physical hardware processors or the combination of hardware and software processors. Processor 103 is configured to take in the input for the system, which can include camera images from the camera 101 for gestures or interactions detected on projected UI 111. Processor 103 can process the gestures or interactions through utilization of a deep learning recognition algorithm as described herein. Depending on the desired implementation, processor 103 can be replaced by special purpose hardware to facilitate the implementations of the deep learning recognition, such as a dedicated graphics processing unit (GPU) configured to process the images for recognition according to the deep learning algorithm, a field programmable gate array (FPGA), or otherwise according the desired implementation. Further, the system can utilize a mix of computer processors and special purpose hardware processors such as GPUs and FPGAs to facilitate the desired implementation.

FIG. 1(b) illustrates another example hardware configuration, in accordance with an example implementation. In an example implementation the system 120 can also be a portable device that can be integrated with other devices (e.g., such as robots, wearable devices, drones, etc.), carried around as a standalone device, or otherwise according to the desired implementation. In such an example implementation, a GPU 123 or FPGA may be utilized to incorporate faster processing of the camera images and dedicated execution of the deep algorithm. Such special purpose hardware can allow for the faster processing of images for recognition as well as be specifically configured for executing the deep learning algorithm to facilitate the functionality more efficiently than a standalone processor. Further, the system of FIG. 1(b) can also integrate generic central processing units (CPUs) to conduct generic computer functions, with GPUs or FPGAs specifically configured to conduct image recognition and execution of the deep learning algorithm as described herein.

In an example implementation involving a smart desk or smart conference room, a system 100 can be utilized and attached or otherwise associated with a tabletop 110 as illustrated in FIG. 1(a), with the projector system 102 configured to project the UI 111 at the desired location and the desired orientation on the tabletop 110 according to any desired implementation. The projector system 102 in such an implementation can be in the form of a mobile projector, a holographic projector, a large screen projector and so on according to the desired implementation. Camera system 101 can involve a camera configured to record depth information and color information to capture actions as described herein. In an example implementation, camera system 101 can also include one or more additional cameras to record the people near the tabletop for conference calls made to other locations and visualized through display 105, the connections, controls, and interactions of which can be facilitated through the projected UI 111. The additional cameras can also be configured to scan documents placed on the tabletop 110 after receiving commands through the projected UI 111. Other smart desk or smart conference room functionalities can also be facilitated through the projected UI 111, and the present disclosure is not limited to any particular implementation.

In an example implementation involving a system 120 for projecting a user interface 111 onto a surface or holographically at any desired location, system 120 can be in the form of a portable device configured with a GPU 123 or FPGA configured to conduct dedicated functions of the deep learning algorithm for recognizing actions on the projected UI 111. In such an example implementation, a UI can be projected at any desired location whereupon recognized commands are transmitted remotely to a control system via I/F 106 based on the context of the location and the projected UI 111. For example, in a situation such as a smart factory involving several manufacturing processes, the user of the device can approach a process within the smart factory and modify the process by projecting the UI 111 through projector system 102 either holographically in free space or on a surface associated with the process. The system 120 can communicate with a remote control system or control server to identify the location of the user and determine the context of the UI to be projected, whereupon the UI is projected from the projection system 102. Thus, the user of the system 120 can bring up the UI specific to the process within the smart factory and make modifications to the process through the projected user interface 111. In another example implementation, the user can select the desired interface through the projected user interface 111 and control any desired process remotely while in the smart factory. Further, such implementations are not limited to smart factories, but can be extended to any implementation in which a UI can be presented for a given context, such as for a security checkpoint, door access for a building, and so on according to the desired implementation.

In another example implementation involving system 120 as a portable device, a law enforcement agent can equip the system 120 with the camera system 101 involving a body camera as well as the camera utilized to capture actions as described herein. In such an example implementation, the UI can be projected holographically or on a surface to recall information about a driver in a traffic stop, for providing interfaces for the law enforcement agent to provide documentation, and so on according to the desired implementation. Access to information or databases can be facilitated through I/F 106 to connect the device to a remote server.

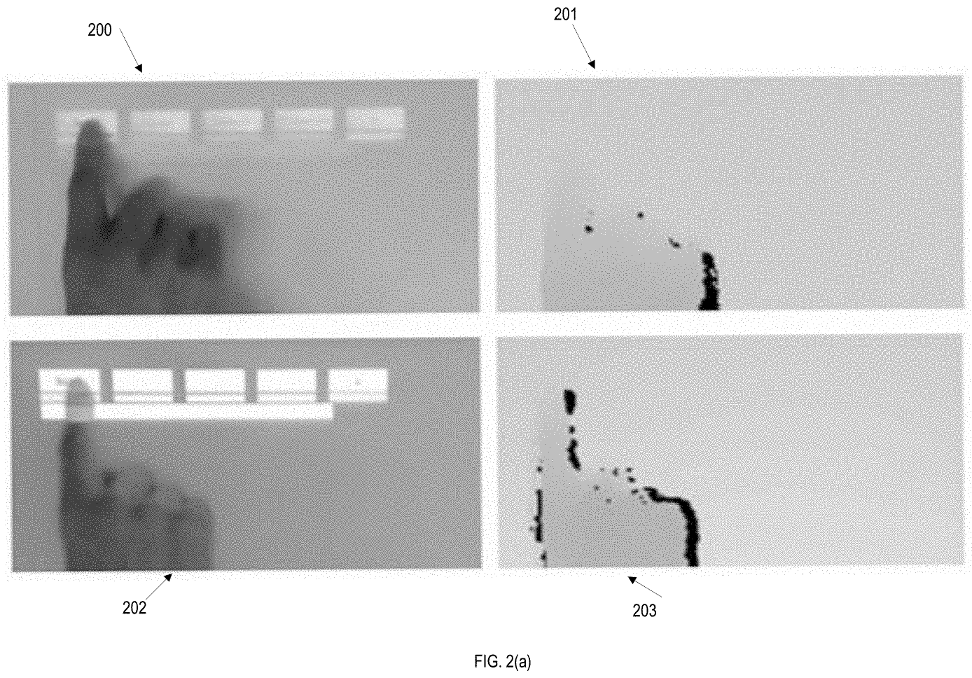

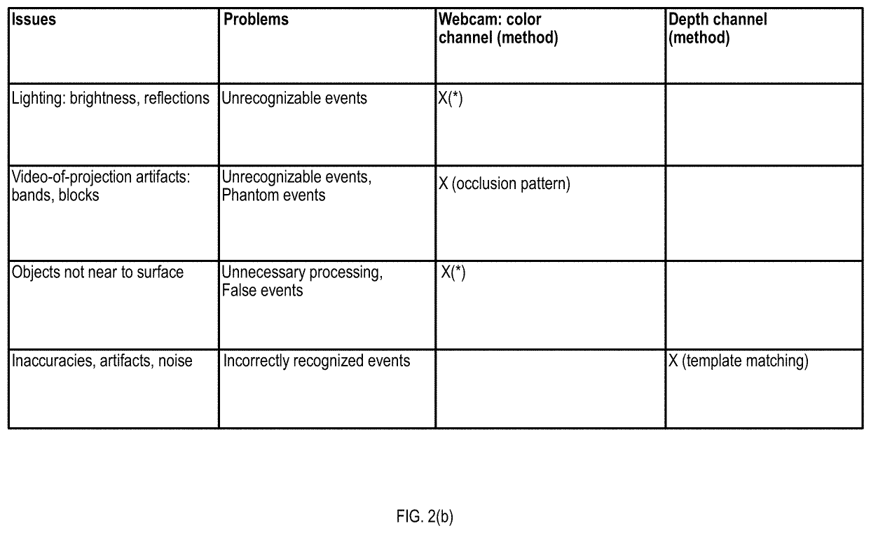

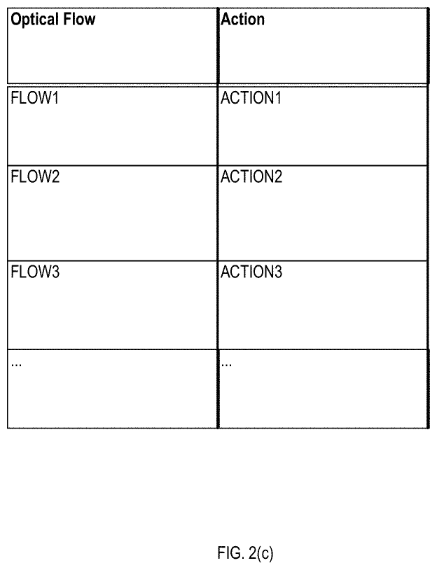

One problem of the related art is the ability to recognize gesture actions on UI widgets. FIG. 2(a) illustrates example sample frames for a projector and camera system, in accordance with an example implementation. In related art systems, various computer vision and image processing techniques have been developed. Related art approaches involve modelling the finger or the arm, which typically involves some form of template matching. Another related art approach is to use occlusion patterns caused by the finger. However, such approaches have problems caused by several issues with projector-camera systems and with the environmental conditions. One issue in the related art approach is the lighting in the environment: brightness and reflections can affect the video quality and cause unrecognizable events. As illustrated in FIG. 2(a), example implementations described herein operate such that detection 201 can be conducted when the lighting is low 200, and detection 203 can be conducted when the lighting is higher 202. With a projector-camera system in which the camera is pointed at a projection image, there can be artifacts such as rolling bands or blocks that show up in the video frames (e.g., the black areas next to the finger in depth image 203), which can cause unrecognizable or phantom events. With only a standard camera (e.g., image without depth information), all the video frames need be processed heavily, which uses up CPU/GPU cycles and energy. With the depth channel, there are inaccuracies and noise, which can cause incorrectly recognized events. These issues and problems, along with the methods that are affected by them, are summarized in FIG. 2(b).

Example implementations address the problems in the relate art by utilizing a deep neural net approach. Deep Learning is a state-of-the-art method that has achieved results for variety of artificial intelligence (AI) problems including computer vision problems. Example implementations described herein involve a deep neural net architecture which uses a CNN along with dense optical flow images computed from the color and depth video channels as described in detail herein.

Example implementations were tested using a RGB-D (Red Green Blue Depth) camera configured to sense video with color and depth. Labeled data was collected through a projector-camera setup with a special touchscreen surface to log the interaction events, whereupon a small set of gesture data was collected from users interacting with a button UI widget (e.g., press, swipe, other). Once the data was labeled and deep learning was conducted on the data set, example implementation gesture/interaction detection algorithms generated from the deep learning methods performed with high robustness (e.g., 95% accuracy in correctly detecting the intended gesture/interaction). Using the deep learning models trained on the data, a projector-camera system can be deployed (without the special touchscreen device for data collection).

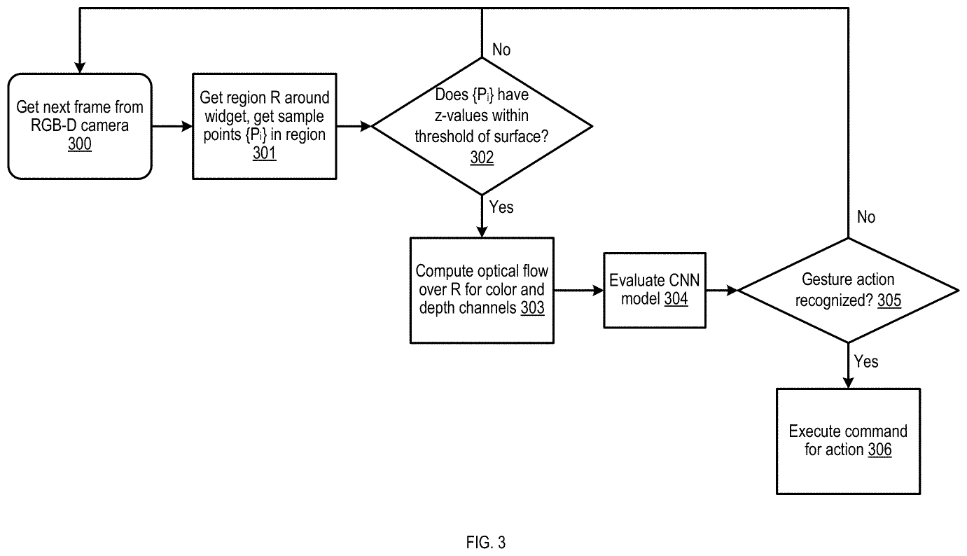

As described herein, FIGS. 1(a) and 1(b) illustrate example hardware setups, and example frames that can be recorded are illustrated in FIG. 2(a). FIG. 3 illustrates an example flow diagram for the video frame processing pipeline, in accordance with an example implementation. At 300, a frame is retrieved from the RGB-D camera.

At 301, the first part of the pipeline uses the depth information from the camera to check whether something is near the surface on top of a region R around a UI widget (e.g. a button). The z-values of a small subsample of pixels {Pi} in R can be checked at 302 to see if they are above the surface and within some threshold to the z-value of the surface. If so (yes) the flow proceeds to 303, otherwise if not (no), no further processing is required and the flow reverts back to 300. Such example implementations save unnecessary processing cycles and energy consumption.

At 303, the dense optical flow is computed over the region R for the color and depth channels. One motivation for using optical flow is that it is robust against different background scenes, which helps to facilitate example implementations recognize gestures/interactions over different user interface designs and appearances. Another motivation is that it can be more robust against image artifacts and noise than related art approaches that models the finger or are based on occlusion patterns. The optical flow approach has been shown to work successfully for action recognition in videos. Any technique known in the art can be utilized to compute the optical flow such as the Farnebäck algorithm in the OpenCV computer vision library. The optical flow processing produces an x-component image and a y-component image for each channel.

Example implementations of the deep neural network for recognizing gesture actions with UI widgets can involve the Cognitive Toolkit (CNTK), which can be suitable for integration with interactive applications on an operating system, but is not limited thereto and other deep learning toolkits (e.g., TensorFlow) can also be utilized in accordance with the desired implementation. Using deep learning toolkits, a standard CNN architecture with two alternating convolution and max-pooling layers can be utilized on the optical flow image inputs.

Thus at 304, the optical flow is evaluated against the CNN architecture generated from the deep neural network. At 305, a determination is made as to whether the gesture action is recognized. If so (Yes), then the flow proceeds to 306 to execute a command for an action, otherwise (No) the flow proceeds back to 300.

In an example implementation for training and testing the network, labeled data can be collected using a setup involving a projector-camera system and a touchscreen covered with paper on which the user interface is projected. The touchscreen can sense the touch events through the paper, and each touch event timestamp and position can be logged. The timestamped frames corresponding to the touch events are labeled according to the name of the pre-scripted tasks, and the regions around the widgets intersecting the positions are extracted. From the camera system, frame rates around 35-45 frames per second for both color and depth channels could be obtained, with the frames synchronized in time and spatially aligned.

For proof-of-concept testing, a small set of data (1.9 GB) with three users, each performing tasks over three sessions was conducted. The tasks involved performing gestures on projected buttons. The gestures were divided into classes {Press, Swipe, Other}. The Press and Swipe gestures are performed with a finger. For the “Other” gestures, the palm was used to perform gestures. Using the palm is a way to get a common type of “bad” events; this is similar to the “palm rejection” feature of tabletop touchscreens and pen tablets. The frames with an absence of activity near the surface were not processed, which is filtered out as illustrated in FIG. 3.

Using ⅔ of the data (581 frames), balanced across the users and session order, the network was trained. Using the remaining ⅓ of the data (283 frames), the network was tested. The experimental results indicated roughly 5% error rate (or roughly 95% accuracy rate) on the optical flow stream (color, x-component).

Further, the example implementations described herein can be supplemented to increase the accuracy, in accordance with the desired implementation. Such implementations can involve the fusion of the optical flow streams, voting by the frames within a contiguous interval (e.g. 200 ms interval) where a gesture may occur, using a sequence of frames and extend the architecture to employ recurrent neural networks (RNN), and/or incorporating spatial information from the frames in accordance with the desired implementation.

FIG. 2(c) illustrates an example database of optical flows as associated with labeled actions in accordance with an example implementation. The optical flows can be in the form of video images or frames which can include the depth channel information as well as the color information. The action is the recognized gesture associated with the optical flow. Through this database, deep learning implementations can be utilized as described above to generate a deep learning algorithm for implementation. Through the use of a database, any desired gesture action or action (e.g., two finger swipe, palm press, etc.) can be configured for recognition in accordance with the desired implementation.

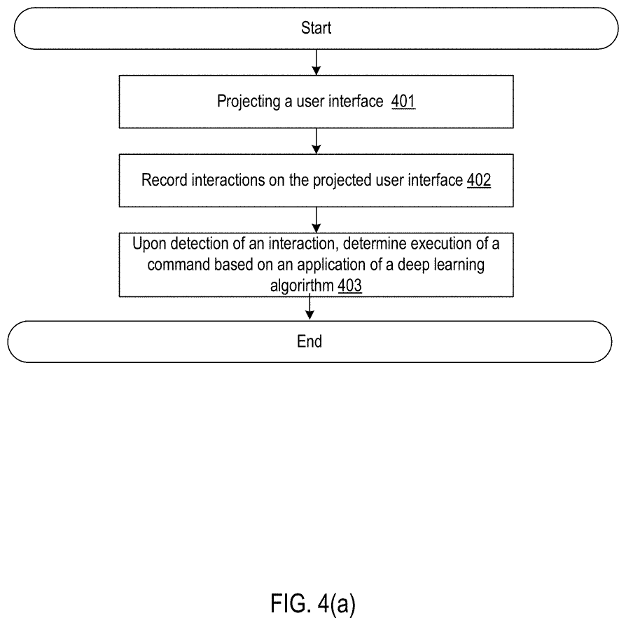

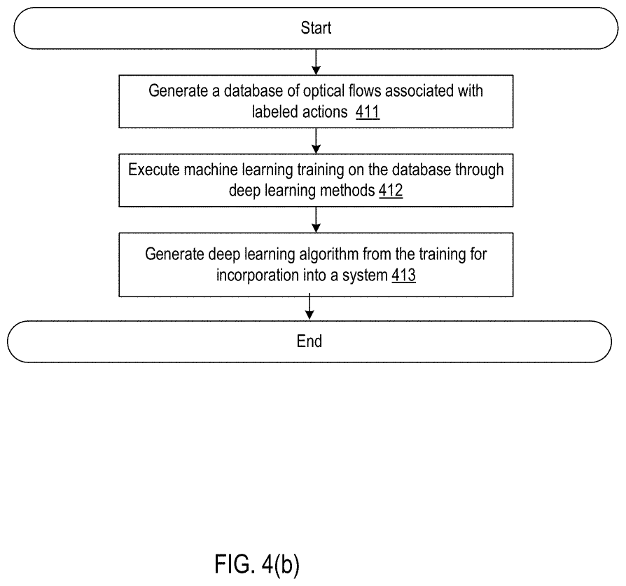

FIG. 4(a) illustrates an example overall flow, in accordance with an example implementation. In an example implementation according to FIGS. 1(a) and 1(b) and through the execution of the flow diagram of FIG. 3, there can be a system which involves a projector system 102, configured to project a user interface (UI) at 401; a camera system 101, configured to record interactions on the projected user interface at 402; and a processor 103/123, configured to upon detection of an interaction recorded by the camera system, determine execution of a command for action based on an application of a deep learning algorithm trained to recognize gesture actions from the interaction recorded by the camera system at 403.

In example implementations, the processor 103/123 can be configured to conduct detection of the interaction recorded by the camera system through a determination, from depth information from the camera system, whether an interaction has occurred in proximity to a UI widget of the projected user interface as illustrated in the flow from 300 to 302 in FIG. 3. For the determination that the interaction has occurred in the proximity to the UI widget of the projected user interface, the processor 103/123 is configured to determine that the interaction is detected, conduct the determination of the execution of the command for action based on the application of the deep learning algorithm, and execute the command for action corresponding to a recognized gesture action determined from the deep learning algorithm as illustrated in the flow of FIG. 3, and for the determination that the interaction has not occurred in the proximity to the UI widget of the projected user interface, determination that the interaction is not detected and not conducting the application of the deep learning algorithm as illustrated in the flow at 302. Through such an example implementation, processing cycles can be saved by engaging the deep learning algorithm only when actions are detected, which can be important, for example, for portable devices running on battery systems that need to preserve battery.

In an example implementation, the processor 103/123 is configured to determine execution of the command for action based on the application of the deep learning algorithm trained to recognize gesture actions from the interaction recorded by the camera by computing an optical flow for a region within the projected UI for color channels and depth channels of the camera system; and applying the deep learning algorithm on the optical flow to recognize a gesture action as illustrated in the flow of 303 to 305 of FIG. 3.

Depending on the desired implementation, the processor 103/123 can be in the form of a graphics processor unit (GPU) or a field programmable gate array (FPGA) as illustrated in FIG. 1(b) configured to execute the application of the deep learning algorithm.

As illustrated in FIG. 1(a), the projector system 102 can be configured to project the UI on a tabletop 110, that depending on the desired implementation, can be attached to the system 100. The system of claim 1, wherein the deep learning algorithm is trained against a database involving labeled gesture actions associated with optical flows. The optical flows can involve actions associated with video frames depending on the desired implementation.

In an example implementation, processor 103/123 can be configured to, upon detection of an interaction recorded by the camera system, compute an optical flow for a region within the projected UI for color channels and depth channels of the camera system; apply a deep learning algorithm on the optical flow to recognize a gesture action, the deep learning algorithm trained to recognize gesture actions from the optical flow; and for the gesture action being recognized, execute a command corresponding to the recognized gesture action as illustrated in the flow from 303 to 305.

Further, the example implementations described in herein and as implemented in FIGS. 1(a) and 1(b) can be implemented as a standalone device, in accordance with a desired implementation.

FIG. 4(b) illustrates an example flow to generate a deep learning algorithm as described in the present disclosure. At 411, a database of optical flows associated with labeled actions is generated as illustrated in FIG. 2(c). At 412, machine learning training is executed on the database through deep learning methods. At 413, a deep learning algorithm is generated from the training for incorporation into the system of FIGS. 1(a) and 1(b).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

1. A system, comprising:
a projector system, configured to project a user interface (UI) directly outwards onto a real world location;
a camera system, configured to record interactions on the projected user interface; and
a processor, configured to:
upon detection of an interaction recorded by the camera system, determine execution of a command for action based on an application of a deep learning algorithm trained to recognize gesture actions from the interaction recorded by the camera system.

2. The system of claim 1, wherein the processor is configured to:
conduct detection of the interaction recorded by the camera system through a determination, from depth information from the camera system, whether an interaction has occurred in proximity to a UI widget of the projected user interface;
for the determination that the interaction has occurred in the proximity to the UI widget of the projected user interface, determine that the interaction is detected, conduct the determination of the execution of the command for action based on the application of the deep learning algorithm, and execute the command for action corresponding to a recognized gesture action determined from the deep learning algorithm; and
for the determination that the interaction has not occurred in the proximity to the UI widget of the projected user interface, determination that the interaction is not detected and not conducting the application of the deep learning algorithm.

3. The system of claim 1, wherein the processor is configured to determine execution of the command for action based on the application of the deep learning algorithm trained to recognize gesture actions from the interaction recorded by the camera by:
computing an optical flow for a region within the projected UI for color channels and depth channels of the camera system; and
applying the deep learning algorithm on the optical flow to recognize a gesture action.

4. The system of claim 1, wherein the processor is a graphics processor unit (GPU) or a field programmable gate array (FPGA) configured to execute the application of the deep learning algorithm.

5. The system of claim 1, wherein the real world location is a tabletop or a wall surface.

6. The system of claim 1, wherein the deep learning algorithm is trained against a database comprising labeled gesture actions associated with optical flows.

7. A system, comprising:
a projector system, configured to project a user interface (UI) directly outwards onto a real world location;
a camera system, configured to record interactions on the projected user interface; and
a processor, configured to:
upon detection of an interaction recorded by the camera system:
compute an optical flow for a region within the projected UI for color channels and depth channels of the camera system;
apply a deep learning algorithm on the optical flow to recognize a gesture action with a UI widget, the deep learning algorithm trained to recognize gesture actions from the optical flow; and
for the gesture action being recognized, execute a command corresponding to the recognized gesture action and the UI widget.

8. The system of claim 7, wherein the processor is configured to:
conduct detection of the interaction recorded by the camera system through a determination, from depth information from the camera system, whether an interaction has occurred in proximity to the UI widget of the projected user interface;
for the determination that the interaction has occurred in the proximity to the UI widget of the projected user interface, determine that the interaction is detected, conduct the determination of the execution of the command for action based on the application of the deep learning algorithm, and execute the command for action corresponding to a recognized gesture action determined from the deep learning algorithm; and
for the determination that the interaction has not occurred in the proximity to the UI widget of the projected user interface, determination that the interaction is not detected and not conducting the application of the deep learning algorithm.

9. The system of claim 7, wherein the processor is a graphics processor unit (GPU) or a field programmable gate array (FPGA) configured to execute the application of the deep learning algorithm.

10. The system of claim 7, wherein the real world location is a tabletop or a wall surface.

11. The system of claim 7, wherein the deep learning algorithm is trained against a database comprising labeled gesture actions associated with video frames.

12. The system of claim 7, wherein the camera system is configured to record on a color channel and on a depth channel.

13. A device, comprising:
a projector system, configured to project a user interface (UI) directly outwards onto a real world location;
a camera system, configured to record interactions on the projected user interface; and
a special purpose hardware processor, configured to apply a deep learning algorithm trained to recognize gesture actions from an interaction recorded by the camera system upon detection of the interaction recorded by the camera system, the special purpose hardware processor configured to:
for a non-detection of the interaction, not applying the deep learning algorithm; and for a detection of the interaction, determine execution of a command for action based on an application of the deep learning algorithm.

14. The device of claim 13, wherein the special purpose hardware processor is configured to:
conduct detection of the interaction recorded by the camera system through a determination, from depth information from the camera system, whether an interaction has occurred in proximity to a UI widget of the projected user interface;
for the determination that the interaction has occurred in the proximity to the UI widget of the projected user interface, determine that the interaction is detected, conduct the determination of the execution of the command for action based on the application of the deep learning algorithm, and execute the command for action corresponding to a recognized gesture action determined from the deep learning algorithm; and
for the determination that the interaction has not occurred in the proximity to the UI widget of the projected user interface, determine that the interaction is not detected and not conducting the application of the deep learning algorithm.

15. The device of claim 13, wherein the special purpose hardware processor is configured to determine execution of the command for action based on the application of the deep learning algorithm trained to recognize gesture actions from the interaction recorded by the camera system by:
computing an optical flow for a region within the projected UI for color channels and depth channels of the camera system; and
applying the deep learning algorithm on the optical flow to recognize a gesture action.

16. The device of claim 13, wherein the special purpose hardware processor is a graphics processor unit (GPU) or a field programmable gate array (FPGA) configured to execute the application of the deep learning algorithm.

17. The device of claim 13, wherein the real world location is a tabletop or a wall surface.

18. The device of claim 13, wherein the deep learning algorithm is trained against a database comprising labeled gesture actions associated with optical flows.
